(19) United States
(12) Patent Application Publication
(10) Pub. No.: US 2024/0282486 A1
(43) Pub. Date: Aug. 22, 2024

(54) DEVICE AND METHOD FOR SPLICING AUTOMOTIVE COAXIAL CABLES

(71) Applicant: Aptiv Technologies AG, Schaffhausen (CH)

(72) Inventors: Jack Farrell, Streetsboro, OH (US); Justin Kopelos, Niles, OH (US); Addison Crain, Warren, OH (US); Luke Alexander Bucey, McDonald, OH (US)

(21) Appl. No.: 18/583,165

(22) Filed: Feb. 21, 2024

Related U.S. Application Data
(60) Provisional application No. 63/447,478, filed on Feb. 22, 2023.

(51) Int. Cl. H01B 13/016

(52) U.S. Cl. CPC H01B 13/016

(57) ABSTRACT

A coaxial cable splicing device includes a core connector terminal and a tubular insulation member. The core connector terminal includes a first connection member configured to receive a first core of a first coaxial cable and a second connection member configured to receive a second core of a second coaxial cable therein. A conductive spacing member is positioned between the first connection member and the second connection member. The conductive spacing member includes a first stop surface to engage the first core and a second stop surface to engage the second core. The tubular insulation member includes a cavity configured to receive the core connector terminal, the first core of the first coaxial cable, and the second core of the second coaxial cable therein.

### CROSS-REFERENCE TO RELATED APPLICATION

This application claims benefit of priority to U.S. Provisional Application No. 63/447,478, titled “Device and Method for Splicing Coaxial Cables”, filed on Feb. 22, 2023, the entire disclosure of which is hereby incorporated by reference.

### BACKGROUND

The present disclosure relates generally to coaxial cable splicing devices, systems, and methods for automotive coaxial cables.

In general, a coaxial cable comprises a core conductor, a dielectric layer surrounding the core conductor, an outer conductive sheath (e.g., a conductive braid) surrounding the dielectric layer, and an outer insulation layer surrounding the outer conductive sheath. Coaxial cables are often used in automotive applications to transfer signals between various automotive sensors, vehicle controls, and/or vehicle systems. Because the outer conductive sheath contains the electric field and magnetic field of the signal (i.e., current) flowing through the core conductor, coaxial cables provide good performance, protecting the signal from outside interference. As a result, a large number of coaxial cables can be positioned near each other without interference from adjacent coaxial cables degrading the signals. In general, damaged automotive coaxial cables are generally removed and replaced with an entirely new coaxial cable. It would be beneficial to develop a device and/or method for repairing damaged coaxial cables without degrading performance of the cable.

### OVERVIEW

According to some embodiments, an automotive coaxial cable splicing device includes a core connector terminal and a tubular insulation member. The core connector terminal includes a first connection member configured to receive a first core of a first coaxial cable and a second connection member configured to receive a second core of a second coaxial cable therein. The conductive spacing member includes a first stop surface to engage the first core and a second stop surface to engage the second core. The tubular insulation member includes a cavity configured to receive the core connector terminal, the first core of the first coaxial cable, and the second core of the second coaxial cable therein.

According to some embodiments, a method for splicing an automotive coaxial cable includes crimping a core connector terminal to a first core and a second core of the automotive coaxial cable. The core connector terminal includes a first connection member configured to receive the first core and a second connection member configured to receive the second core. A conductive spacing member is positioned between the first connection member and the second connection member. The method includes receiving the core connector terminal within a cavity of a tubular insulation member. An outer sheath is positioned around the tubular insulation member. The outer sheath includes a conductive layer.

According to some embodiments, a system for splicing an automotive coaxial cable including a conductive core, a dielectric layer, and an outer sheath conductor. The system includes a core connector terminal including a first connection member electrically connectable to a first end of the conductive core of the automotive coaxial cable. A second connection member is electrically connectable to a second end of the conductive core of the automotive coaxial cable. A conductive spacing member is positioned between the first connection member and the second connection member. The system includes a tubular insulation member, The tubular insulation member includes a first shell, a second shell, a hinge connecting the first shell and the second shell, a first distal end having a first width, and a second distal end having a second width. A cavity is formed between the first shell and the second shell. The cavity is positioned between the first distal end and the second distal end. The core connector terminal is receivable within the cavity of the tubular insulation member.

These and other examples and features of the present devices, systems, and methods will be set forth, at least in part, in the following Detailed Description. This Overview is intended to provide non-limiting examples of the present subject matter—it is not intended to provide an exclusive or exhaustive explanation. The Detailed Description below is included to provide further information about the present devices, systems, and methods.

### BRIEF DESCRIPTION OF DRAWINGS

This written disclosure describes illustrative embodiments that are non-limiting and non-exhaustive. Reference is made to illustrative embodiments that are depicted in the figures, in which:

FIG. 1A illustrates a cross sectional side view of an automotive cable splicing device, according to some embodiments.

FIG. 1B illustrates a cross sectional isometric view of an automotive cable splicing device, according to some embodiments.

FIG. 2 illustrates an exploded isometric view of a core connector terminal and a tubular insertion member aligned with a longitudinal axis of a coaxial cable, according to some embodiments.

FIG. 3A illustrates a top view of an uncrimped core connector terminal, according to some embodiments.

FIG. 3B illustrates an isometric view of a partially crimped core connector terminal, according to some embodiments.

FIG. 3C illustrates an isometric view of a partially crimped core connector terminal, according to some embodiments.

FIG. 4A illustrates an isometric view of a partially crimped core connector terminal aligned with a coaxial cable, according to some embodiments.

FIG. 4B illustrates an isometric view of a partially crimped core connector terminal with a first tubular member crimped to a core of a coaxial cable, according to some embodiments.

FIG. 5 illustrates an isometric view of a tubular insulation member secured to a coaxial cable, according to some embodiments.

FIG. 6 illustrates an isometric view of a tubular insulation member, according to some embodiments.

FIG. 7 illustrates a graph of coaxial splice shielding signal attenuation, according to some embodiments.

FIG. 8 illustrates a flow chart of a method for splicing an automotive coaxial cable, according to some embodiments.

### DETAILED DESCRIPTION

According to some embodiments, this disclosure relates to devices, systems, and methods for splicing automotive coaxial cables. In some embodiments, an automotive coaxial cable splicing device includes a core connector terminal and a tubular insulation member. An automotive coaxial cable includes a core, a dielectric layer surrounding the core, an outer conductive sheath surrounding the dielectric layer, and an insulation layer surrounding the outer conductive sheath. The core connector terminal receives a first core (associated with a first coaxial cable) and a second core (associated with a second coaxial cable). The core connector terminal is electrically conductive to electrically couple the first core the second core. The core connector terminal is received within the tubular insulation member. In some embodiments, the tubular insulation member is received within an outer sheath including a conductive layer.

In some embodiments, the core includes a core diameter and the dielectric layer includes a first dielectric diameter. The core connector terminal includes a terminal diameter, and the dielectric tubular insulation member includes a second dielectric diameter. The terminal diameter is greater than the core diameter. The ratio of the core diameter to the first dielectric diameter (i.e., the coaxial cable ratio) may be approximately equal to the ratio of the terminal diameter to the second dielectric diameter (i.e., the slicing device ratio). The conductor to dielectric ratio affects the characteristic impedance of the coaxial cable, and therefore, in some embodiments it is beneficial to maintain a constant conductor to dielectric ratio throughout the coaxial cable and spliced section. Changes to the conductor to dielectric ratio results in unwanted impedances which degrade signal transmission (e.g., cause signal reflection, interference, or other signal noise). In some embodiments, a dielectric constant of the dielectric tubular insulation member is different from the dielectric constant of the dielectric layer. In such cases, the conductor to dielectric ratio is configured to keep the characteristic impedance constant.

In some embodiments, the core connector terminal includes conductive spacing member including a first stop surface and a second stop surface. The first stop surface engages the end of the first core and the second stop surface engages the end of the second core. The conductive spacing member ensures a predetermined length of the core is received within the core connector terminal, and thus, a gap distance between the dielectric layer of the coaxial cable and the core connector terminal is controlled. Controlling the gap distance between the dielectric layer of the coaxial cable and the core terminal is important, as the tubular insulation member may be shaped to precisely fill the gap distance therebetween. If the tubular insulation does not precisely fill the gap, air pockets may be present within the tubular insulation member (air having a different dielectric constant/relative permittivity than the dielectric material) which may result in unwanted impedances which degrade signal transmission (e.g., cause signal reflection, interference, or other signal noise). Thus, it is beneficial to form a precise fit between the tubular insulation member, the core connector terminal, and the coaxial cable.

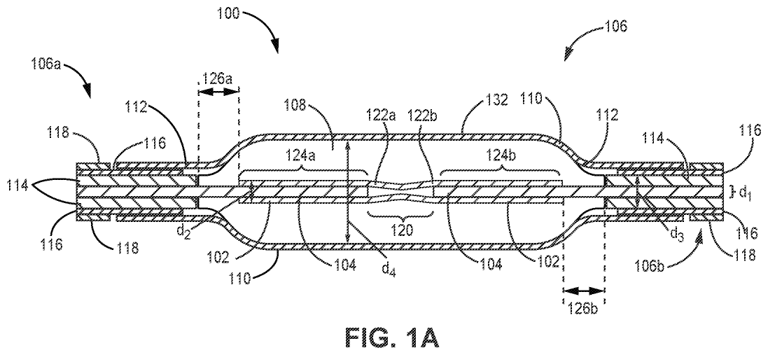

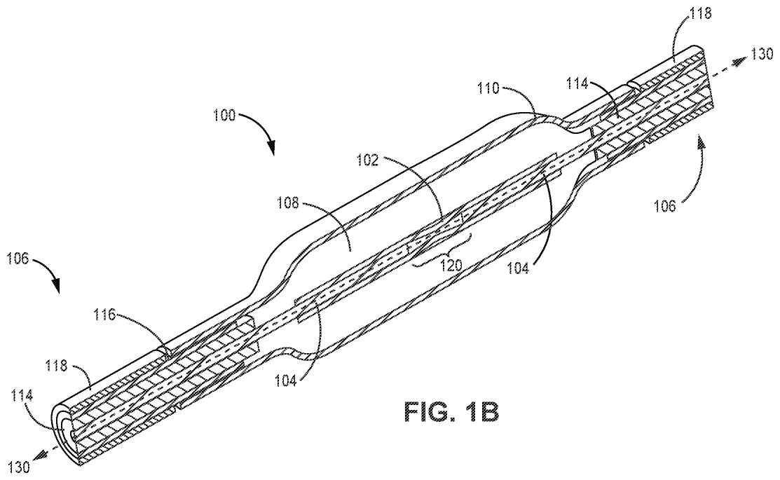

FIGS. 1A-B illustrate cross sectional views of an automotive cable splicing device 100. In some embodiments, the automotive cable splicing device 100 includes a core connector terminal 102, a tubular insulation member 108, and an outer sheath 110 including a conductive layer 112. In some embodiments, a coaxial cable 106 includes a core 104, a dielectric layer 114, an outer shield conductor 116, and an outer insulation layer 118. The coaxial cable 106 extends along a longitudinal axis 130 (as illustrated in FIG. 1B), however, the coaxial cable 106 is flexible to bend or deflect away from the longitudinal axis 130 illustrated in FIG. 1B. The coaxial cable 106 is spliced together, i.e., a first coaxial cable 106a is connected to (or joined with) a second coaxial cable 106b, which together form the coaxial cable 106. The first end 106a of the coaxial cable 106 may be referred to hereinafter as the first coaxial cable and the second end 106b of the coaxial cable 106 may be referred to hereinafter as the second coaxial cable. In some embodiments, the core 104, the dielectric layer 114, the outer shield conductor 116, and the outer insulation layer 118 may be identical between the first coaxial cable 106a and the second coaxial cable 106b (e.g., formed of the same materials and dimensions).

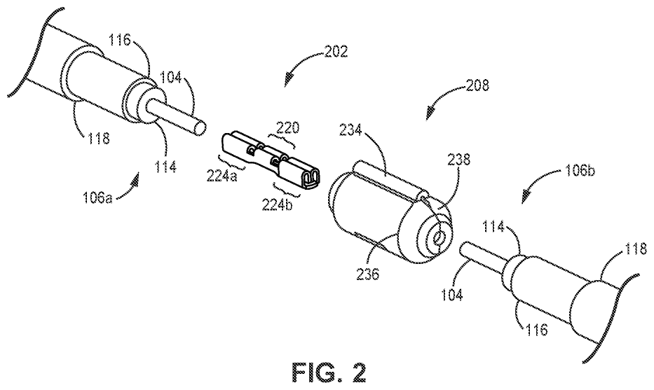

In some embodiments, the core connector terminal 102 includes a first connection member 124a, a second connection member 124b, and a conductive spacing member 120 therebetween (the first connection member 124a and the second connection member 124b may also be referred to as attachment members). The first connection member 124a receives the core 104 of the first coaxial cable 106a and the second connection member 124b receives the core 104 of the second coaxial cable 106b. In some embodiments, the first connection member 124a and the second connection member 124b are tubular members, i.e., formed as a substantially cylindrical shape to receive the substantially cylindrical core 104 therein. The first connection member 124a and the second connection member 124b are crimped onto the core 104, according to some embodiments. The core connector terminal 102 includes a conductive material and a conductive path to electrically connect the core 104 of the first coaxial cable 106a and the core 104 of the second coaxial cable 106b. In some embodiments, the conductive spacing member 120 includes a first stop surface 122a and a second stop surface 122b. The first stop surface 122a engages the core 102 of the first coaxial cable 106a to act as a stopping member, i.e., preventing further insertion of the core within the core connector terminal 102. The second stop surface 122b engages the core 102 of the second coaxial cable 106b to act as a stopping member. The conductive spacing member 120 may be formed by crimping a portion of the core connector terminal 102, or in other embodiments, the conductive spacing member 120 may be a pre-formed structural element. In some embodiments, the core connector terminal 102 is a hollow, tubular member. In other embodiments, the core connector terminal 102 is a multi-winged conductive element that is crimped to form tubular features to receive the core 102 (see e.g., FIGS. 2-4B).

In some embodiments, the first stop surface 122a and the second stop surface 122b of the conductive spacing member 120 are positioned to create a first gap distance 126a between the first connection member 124a of the core connector terminal 102 and the dielectric layer 114 of the first coaxial cable 106a. A second gap distance 126b is created between the second connection member 124b of the core connector terminal 102 and the dielectric layer 114 of the second coaxial cable 106b by the position of the second stop surface 122b. The tubular insulation member 108 is sized to fill the first gap distance 126a and the second gap distance 126b. Controlling the first gap distance 126a and the second gap distance 126b is beneficial, as the tubular insulation member 108 is sized to fill the first gap distance 126a and the second gap distance 126b and thereby remove air gaps within the coaxial cable splicing device 100. In some embodiments, the tubular insulation member 108 includes a dielectric material having a substantially similar dielectric constant to the dielectric layer 114. In some embodiments, a first distal end of the tubular insulation member 108 contacts the dielectric layer 114 of the first coaxial cable 106a and a second distal end of the tubular insulation member 108 contacts the dielectric layer 114 of the second coaxial cable 106b.

In some embodiments, a characteristic impedance of the coaxial cable 106 is expressed as: Z₀=\sqrt{μ0/ε0εr}*ln(b/a)/2π, where b is the diameter of a dielectric, a is the diameter of the conductor, εᵣ is the dielectric constant of the dielectric material, ε₀ is the vacuum permittivity constant, and μ₀ is permeability of free space constant. The two main parameters that affect the characteristic impedance are the ratio (b/a) and the dielectric constant εᵣ of the dielectric material.

In some embodiments, the core 104 has a first diameter d₁, the core connector terminal 102 has a second diameter d₂, the dielectric layer 114 has a third diameter d₃, and the tubular insulation member 108 has a fourth diameter d₄. The second diameter d₂ of the core connector terminal 102 is greater than the first diameter d₁ of the core 104 because the core connector terminal 102 is sized to at least partially receive the core 104. The third diameter d₃ of the dielectric layer 114 to the first diameter d₁ of the core 104 is characterized as a first dielectric to conductor ratio (i.e., d₃/d₁ is the first dielectric to conductor ratio). The fourth diameter d₄ of the tubular insulation member 108 to the second diameter d₂ of the core connector terminal 102 is characterized as a second dielectric to conductor ratio (i.e., d₄/d₂ is the second dielectric to conductor ratio). In some embodiments, the first dielectric to conductor ratio is approximately equal to the second dielectric to conductor ration (d₃/d₁=d₄/d₂). In some embodiments, the dielectric to conductor ratio of the entire coaxial cable 106 and the coaxial cable splicing device 100 may be approximately constant at all locations (e.g., at all cross sections orthogonal to the longitudinal axis 130 of the coaxial cable 106, the dielectric to conductor ratio is approximately d₃/d₁).

The dielectric to conductor ratio affects the characteristic impedance of the coaxial cable 106, and therefore, the geometric parameters of the dielectric diameter and conductor diameter are scaled together to maintain a constant characteristic impedance. If for example, the characteristic impedance changes throughout the length of a coaxial cable, signal reflection, signal interference, and signal noise would be generated by the changing characteristic impedance. Therefore, it may be beneficial to maintain the same dielectric to conductor ratio throughout the coaxial cable 106 and the coaxial cable splicing device 100.

In some embodiments, a first dielectric constant of the dielectric layer 114 and a dielectric constant of the tubular insulation member 108 are not identical. For example, if the dielectric to conductor ratio (e.g., b/a) is not constant throughout the coaxial cable 106 and the coaxial cable splicing device 100, the characteristic impedance can be held approximately constant by selecting the first dielectric constant and/or the second dielectric constant to counteract the inconsistent dielectric to conductor ratio. In other words, the two variables that affect the characteristic impedance of the coaxial cable are (1) the dielectric to conductor ratio (b/a), and (2) the dielectric constant (εᵣ). If one variable changes (e.g., if the dielectric to conductor ratio changes within the coaxial splicing device), the other variable may be selectively altered to keep the characteristic impedance (Z₀) constant.

In some embodiments, the conductive layer 112 of the outer sheath 110 is positioned on an inner surface of the outer sheath 110. The conductive layer 112 contacts the outer shield conductor 116 (e.g., conductive braid layer) of the coaxial cable 106. The conductive layer 112 electrically couples the outer shield conductor 116 of the first coaxial cable 106a to the outer shield conductor 116 of the second coaxial cable 106b. Electrically coupling the outer shield conductor 116 of the first coaxial cable 106a to the outer shield conductor 116 of the second coaxial cable 106b provides a continuous outer shield layer to prevent signal interference.

In some embodiments, the outer sheath 110 includes a compressive outer layer 132. The compressive outer layer 132 provides a tension and/or compressive force upon the conductive layer 112 to urge the conductive layer 112 radially inward toward the longitudinal axis 130. In some embodiments, the compressive outer layer 132 reinforces the contact between the outer shield conductor 116 and the conductive layer 112 of the outer sheath 110 to ensure the electric connection is maintained through cable bend or deflection. In some embodiments, the compressive outer layer 132 is a heat shrink element. The compressive outer layer 132 may provide a water-tight barrier over the coaxial cable splicing device 100.

FIG. 2 illustrates an exploded isometric view of a tubular insulation member 208 and a core connector terminal 202 aligned with the coaxial cable 106, according to some embodiments. The coaxial cable 106 is split and stripped into the first coaxial cable 106a and the second coaxial cable 106b, each including the core 104, the dielectric layer 114 surrounding the core 104, the outer shield conductor 116 surrounding the dielectric layer 114, and the outer insulation layer 118 surrounding the outer shield conductor 116.

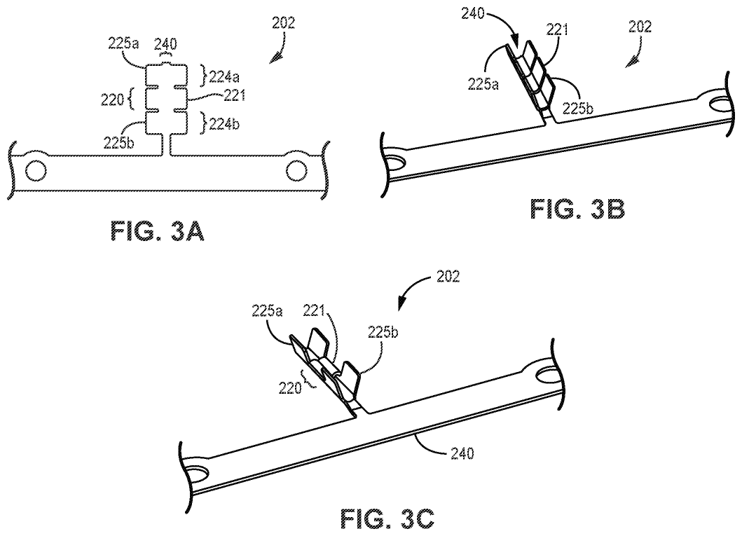

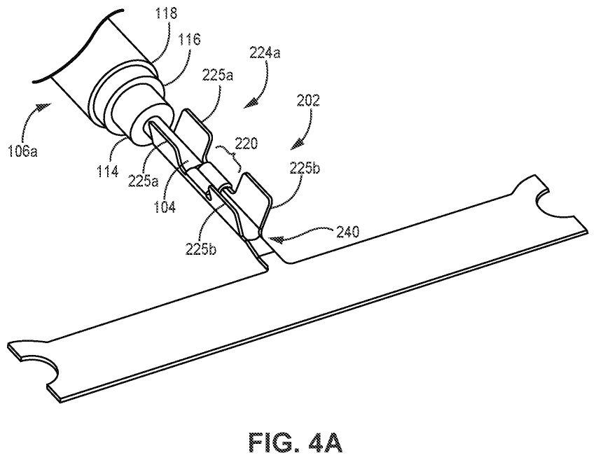

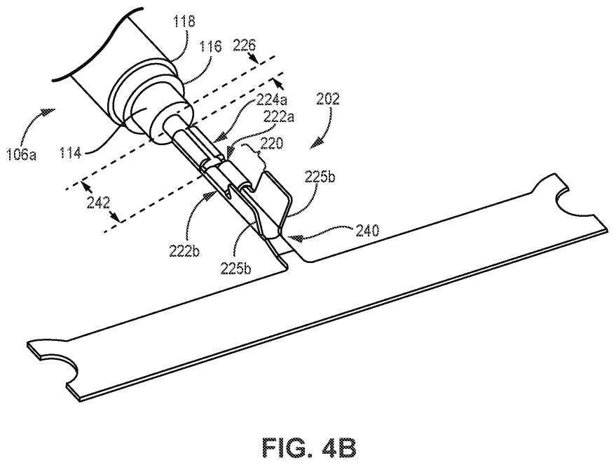

In some embodiments, the core connector terminal 202 includes a conductive spacing member 220, a first attachment member 224a, and a second attachment member 224b (the first attachment member 224a and the second attachment member 224b may also be referred to as connection members). The first attachment member 224a electrically couples to the core 104 of the first coaxial cable 106a and the second attachment member 224b electrically couples to the core 104 of the second coaxial cable 106b. The conductive spacing member 220 is positioned in between the first attachment member 224a and the second attachment member 224b and includes stop members that define the length or extent of the core 104 received by the core connector terminal 202. The embodiment illustrated in FIG. 2 shows the first attachment member 224a and the second attachment member 224b in a crimped state (i.e., the crimp wings illustrated in FIGS. 3A-C have been crimped). In some embodiments, the crimp wings of the first attachment member 224a and the second attachment member 224b are not crimped until the core 104 is inserted between the wings (see e.g., FIGS. 3A-4B).

In some embodiments, the tubular insulation member 208 includes a hinge 234, a first shell 236, and a second shell 238. The hinge 234 couples the first shell 236 to the second shell 238. The hinge 234 pivots/actuates to allow the first shell 236 to swing away from and/or toward the second shell 238. In some embodiments, the hinge 234 actuates to allow the first shell 236 to swing away from the second shell 238. The core connector terminal 202 and/or the coaxial cable 106 are received within the tubular insulation member 208 while the first shell 236 is positioned away from the second shell 238 (i.e., the tubular insulation member 208 is in an open state). Once the core connector terminal 202 and/or the coaxial cable 106 are positioned between the first shell 236 and the second shell 238, the tubular insulation member 208 may be closed via actuation of the hinge 234 urging the first shell 236 toward the second shell 238.

FIG. 3A illustrates a top view of a core connector terminal 202 in an uncrimped state, according to some embodiments. The core connector terminal 202 in the uncrimped state may be formed from a flat sheet of conductive material. In some embodiments, the core connector terminal 202 may include first deformable wings 225a, second deformable wings 225b, and intermediate deformable wings 221 positioned therebetween. The first deformable wings 225a form the first attachment member 224a, the second deformable wings 225b form the second attachment member 224b, and the intermediate deformable wings 221 form the conductive spacing member 220, according to some embodiments. In some embodiments, the crimp wings 221, 225a, 225b have the same geometry (dimensions and shape). In other embodiments, the crimp wings 221, 225a, 225b have different geometries. The core connector terminal 202 includes a base section 240 wherein the wings 221, 225a, 225b are deformed around the base section 240. In some embodiments, each of the first deformable wings 225a, the second deformable wings 225b, and the intermediate deformable wings 221 include at least one wing on each side of the base section 240. For instance, FIG. 3B illustrates the wings 221, 225a, 225b formed upward relative to the base section 240.

FIG. 3C illustrates an isometric view of a partially crimped core connector terminal 202, according to some embodiments. The intermediate deformable wings 221 are crimped (i.e., folded over toward the base section 240) to form the conductive spacing member 220. The first deformable wings 225a and the second deformable wings 225b remain formed upward prior to contact with the core 104 of the coaxial cable 106. In some embodiments, an excess metal strip 240 may assist positioning and orienting the core connector terminal 202 relative to the coaxial cable 106. In some embodiments, the core connector terminal 202 includes any and/or all features of the core connector terminal 102 described above, and vice-versa.

FIG. 4A illustrates the first coaxial cable 106a aligned with the partially crimped core connector terminal 202 shown in FIG. 3C, according to some embodiments. The core 104 of the first coaxial cable 106a is partially received between the pair of first deformable wings 225a. The core 104 is aligned with the base section 240. In some embodiments, a distal tip of the core 104 abuts the conductive spacing member 220. Once the distal tip of the core 104 contacts the conductive spacing member 220, the pair of first deformable wings 225a is crimped to the core via deforming each of the first deformable wings 225a toward the core 104.

For instance, FIG. 4B shows the first deformable wings 225a crimped to the core 104 to form the first attachment member 224a. The first attachment member 224a is a tubular member which at least partially receives the core 104 therein. The core 104 of the first coaxial cable 106a abuts the first stop surface 222a of the conductive spacing member 220. The first stop surface 222a of the conductive spacing member 220 thereby controls a distance 242 between the dielectric layer 114 of the first coaxial cable 106a and the distal end of the core 104 of the first coaxial cable 106a. Likewise, the first stop surface 222a of the conductive spacing member 220 controls a gap distance 226 between the dielectric layer 114 of the first coaxial cable 106a and the first attachment member 224a of the core connector terminal 202. In some embodiments, the core 104 of the second coaxial cable (not shown here) may contact a second stop surface 222b and the pair of second deformable wings 225b may be crimped to the core 104. The second stop surface 222b controls a distance (not shown) between the dielectric layer 114 of the second coaxial cable and the distal end of the core 104 of the second coaxial cable and controls a gap distance (not shown) between the dielectric layer 114 of the second coaxial cable and the second attachment member 224b.

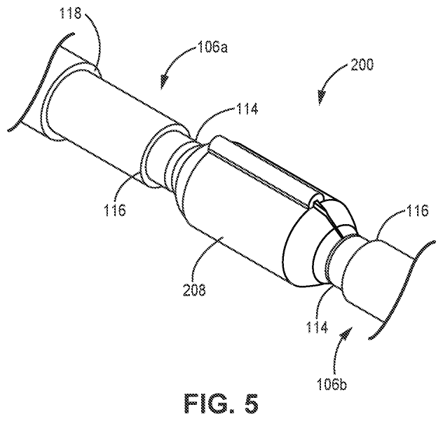

FIG. 5 illustrates an isometric view of the coaxial cable splicing device 200, according to some embodiments. The first coaxial cable 106a and the second coaxial cable 106b each include the dielectric layer 114 surrounded by the outer shield conductor 116 and the outer insulation layer 118 surrounding the outer shield conductor 116. In some embodiments, the automotive coaxial cable splicing device 200 includes the tubular insulation member 208 which contacts the dielectric layer 114 of both the first coaxial cable 106a and the second coaxial cable 106b. In some embodiments, the automotive coaxial cable splicing device 200 includes an outer sheath (not shown) wrapped around the tubular insulation member 208. In one example, the outer sheath includes a conductive layer (e.g., a copper tape wound around the longitudinal axis of the tubular insulation member 208 or a tubular conductive braid inserted/slid over the tubular insulation member 208) which contacts the outer shield conductor of both the first coaxial cable 106a and the second coaxial cable 106b. In one example, the outer sheath includes a heat shrink wrap with a conductive inner lining.

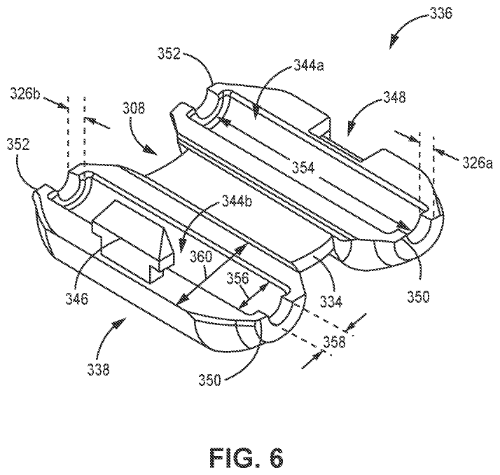

FIG. 6 illustrates an isometric view of a tubular insulation member 308 in an open state, according to some embodiments. In some embodiments, the tubular insulation member 308 includes a first shell 336, a second shell 338, and a hinge 334 pivotally coupling the first shell 336 to the second shell 338. The tubular insulation member 308 includes a locking detent 346 and a locking recess 348 to receive the locking detent 346, according to some embodiments. The first shell 336 and the second shell 338 include a diameter 360 and an aperture having an aperture diameter 358. The first shell 336 includes a first cavity 344a and the second shell includes a second cavity 344b (together forming a tubular cavity 344a, 344b in the tubular insulation member 308). Both of the first cavity 344a and the second cavity 334b include a longitudinal length 354 and a cavity diameter 356. The tubular insulation member 308 includes a first distal end 350 and a second distal end 352. In some embodiments, the first distal end 350 is separated from the cavity 344a, 344b by a gap filling cap 326a, and the second distal end 352 is separated from the cavity 344a, 344b by a gap filling cap 326b. The gap filling caps 326a, 326b are formed of a dielectric material. The gap filling caps 326a, 326b space the core connector terminal 102, 202 from the outer shield conductor 116, and thus, may be referred to as first and second dielectric spacing members, respectively.

In some embodiments, the cavity 344a, 344b is sized to receive the core connector terminal 102, 202 described above in FIGS. 1A-5. The cavity diameter 356 is approximately equal to the diameter of the core connector terminal 102, 202. In some embodiments, the cavity 344a, 344b may include features to mate with and/or align with features of the core connector terminal 102, 202. For instance, the cavity 344a, 344b may include ridges or detents that fill spaces between the first attachment member 224b and the conductive spacing member 220 and/or fill spaces between the second attachment member 224b and the conductive spacing member 220. Such configuration provides proper positioning/alignment of the core connector terminal 102, 202 within the tubular insulation member 208 and/or reduces the size/quality of air gaps between the core connector terminal 102, 202 and the tubular insulation member 208. In some embodiments, the longitudinal length 354 of the cavity 344a, 344b is approximately equal to the length of the core connector terminal 102, 202.

In some embodiments, the tubular insulation member 308 includes gap filling caps 326a, 326b at the first and second distal ends 350, 352. The gap filling end caps 326a, 326b fill the gap distance 226 (see FIG. 4B) between the dielectric layer 114 of the coaxial cable 106 and the attachment member 224a, 224b of the core connector terminal 102, 202. The gap filling end caps 326a, 326b include an aperture with the aperture diameter 358 approximately equal to the diameter of the core 104.

In some embodiments, the hinge 334 pivotally connects the first shell 336 and the second shell 338. FIG. 6 illustrates the tubular insulation member in an open state, i.e., the first shell 336 and the second shell 338 are pivoted away from each other to allow components (e.g., the core connector terminal 102, 202) to be positioned between the first shell 336 and the second shell 338. Once the desired components are positioned between the first shell 336 and the second shell 338, the first shell 336 and the second shell 338 can be urged toward each other via actuation of the hinge 334. In some embodiments, the locking detent 346 is received in the locking cavity 348 and secures the first shell 336 and the second shell 338 together in a closed state. In some embodiments, the tubular insulation member 308 includes any and/or all features of the tubular insulation member 108 and 208 described above, and vice-versa.

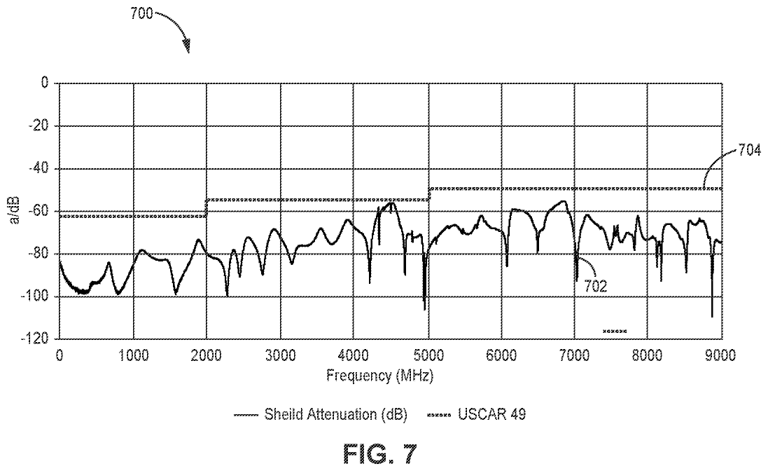

FIG. 7 illustrates an exemplary graph 700 of splice shielding performance, according to some embodiments. The graph 700 includes electromagnetic interference (EMI) shielding measurements 702 of attenuation (a/dB) versus frequency (MHz). The graph includes a USCAR49 threshold 704. USCAR49 is a performance specification for automotive coaxial cables. FIG. The EMI shielding measurements 702 of the automotive coaxial cable splicing device 100, 200 passes the USCAR49 performance specification.

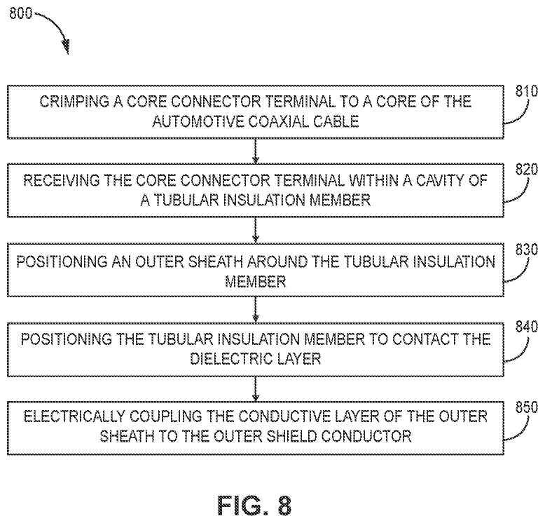

FIG. 8 illustrates a flow chart of a method 800 for splicing an automotive coaxial cable, according to some embodiments. The method 800 includes step 810, crimping a core connector terminal 102, 202 to a core 104 of the automotive coaxial cable 106. In some embodiments, the method 800 may include stripping the coaxial cable 106 to predetermined lengths, i.e., each layer of the coaxial cable 106 may be stripped to a desired length. In some embodiments, a stripping tool or stripping fixture is used to create the desired strip lengths at each layer. At step 810, the core 104 of the first coaxial cable 106a is positioned within the first pair of wings 225a and/or the first attachment member 224a and the core 104 of the second coaxial cable 106b is positioned within the second pair of wings 225b and/or the second attachment member 224b. The core 104 of the first coaxial cable 106a contacts or abuts the first stop surface 222a and the core 104 of the second coaxial cable 106b contacts or abuts the second stop surface 222b prior to crimping, according to some embodiment.

At step 820, the core connector terminal 102, 202 is received within a cavity 344a, 344b of a tubular insulation member 108, 208, 308. In some embodiments, step 820 may include providing the tubular insulation member 108, 208, 308 in an open state and aligning the core connector terminal 102, 202 with the cavity 344a, 344b. The tubular insulation member 108, 208, 308 can be closed via actuation of the hinge 334 and/or by urging the first shell 336 toward the second shell 338.

At step 830, an outer sheath 110 is positioned around the tubular insulation member 108, 208, 308. In some embodiments, the step 830 may include providing the outer sheath 110 with a conductive layer 112 (e.g., copper tape and/or conductive braid). In some embodiments, the conductive layer 112 is positioned to contact the outer shield conductor 116 of the first coaxial cable 106a and the second coaxial cable 106b. In some embodiments, the outer sheath 110 includes a heat shrink tube. The heat shrink tube is positioned on one of the first coaxial cable 106a or the second coaxial cable 106b prior to step 810. After the step 810 and the step 820, the heat shrink tube may be moved (i.e., slid) from one of the first coaxial cable 106a or the second coaxial cable 106b to a position overlapping the tubular insulation member 108, 208, 308. The heat shrink tube may include the conductive layer 112. In other embodiments, the conductive layer 112 may be a copper tape (or other conductive tape) wound around the longitudinal axis 130 of the coaxial cable 106.

At step 840, the tubular insulation member 108, 208, 308 is positioned to contact the dielectric layer 114 of the coaxial cable 106. The first and second distal ends 350, 352 of the tubular insulation member 108, 208, 308 may contact the dielectric layer 114 of the first coaxial cable 106a and the second coaxial cable 106b.

At step 850, the conductive layer 112 of the outer sheath 110 is electrically coupled to the outer shield conductor 116. In some embodiments, the conductive layer 112 is positioned to contact the outer shield conductor 116 of the first coaxial cable 106a and the second coaxial cable 106b.

In some embodiments, the step 810, the step 820, and the step 830 occur sequentially. For example, first the core connector terminal 102, 202 is crimped to the core 104, second the core connector terminal 102, 202 is received within the cavity 344a, 344b of the tubular insulation member 108, 208, 308, and third the outer sheath 110 is positioned around the tubular insulation member 108, 208, 308. The above sequence is beneficial because an operator may check the connection status of the core connector terminal 102, 202 to the core 104 prior to enclosing the connection.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

What is claimed is:

1. A coaxial cable splicing device, comprising:
a core connector terminal including:
a first connection member configured to receive a first core of a first coaxial cable therein,
a second connection member configured to receive a second core of a second coaxial cable therein, and
a conductive spacing member positioned between the first connection member and the second connection member, the conductive spacing member including a first stop surface to engage the first core and a second stop surface to engage the second core; and
a tubular insulation member including a cavity configured to receive the core connector terminal, the first core of the first coaxial cable, and the second core of the second coaxial cable therein.

2. The coaxial cable splicing device of claim 1, wherein the core connector terminal is a one-piece construction including a first set of crimp wings crimped around the first core to form the first connection member and a second set of crimp wings crimped around the second core to form the second connection member.

3. The coaxial cable splicing device of claim 1 further comprising:
an outer sheath including a conductive layer,
wherein the conductive layer of the outer sheath is electrically coupled to a first outer shield conductor of the first coaxial cable and a second outer shield conductor of the second coaxial cable.

4. The coaxial cable splicing device of claim 3, wherein the outer sheath includes a compressive outer layer configured to urge the conductive layer of the outer sheath radially inward toward the first coaxial cable and the second coaxial cable.

5. The coaxial cable splicing device of claim 4, wherein the compressive outer layer includes a heat shrink sheath, wherein the heat shrink sheath provides a water-tight fit upon the first coaxial cable and the second coaxial cable.

6. The coaxial cable splicing device of claim 1, wherein the first stop surface of the conductive spacing member is configured to control a gap distance between the first connection member and a first dielectric layer of the first coaxial cable.

7. The coaxial cable splicing device of claim 6, wherein a first distal end of the tubular insulation member contacts the first dielectric layer of the first coaxial cable and a second distal end of the tubular insulation member contacts a second dielectric layer of the second coaxial cable.

8. The coaxial cable splicing device of claim 7, wherein the tubular insulation member includes a first dielectric spacing member at the first distal end, wherein the first dielectric spacing member is approximately equal length to the gap distance between the first connection member and the first dielectric layer, and wherein the first dielectric spacing member is configured to be received within the gap distance between the first connection member and the first dielectric layer.

9. The coaxial cable splicing device of claim 1, wherein:
a first dielectric constant of a dielectric layer of the first or second coaxial cable is approximately equal to a second dielectric constant of the tubular insulation member,
the first core and the second core have a first outer diameter,
the first connection member and the second connection member have a second outer diameter greater than the first outer diameter,
a first dielectric layer of the first coaxial cable and a second dielectric layer of the second coaxial cable have a third outer diameter,
the tubular insulation member has a fourth outer diameter greater than the third outer diameter, and
wherein a first ratio of the third outer diameter to the first outer diameter is approximately equal to a second ratio of the fourth outer diameter to the second outer diameter.

10. A method for splicing a coaxial cable, the method comprising:
crimping a core connector terminal to a first core and a second core of the coaxial cable, the core connector terminal including:
a first connection member configured to receive the first core,
a second connection member configured to receive the second core, and
a conductive spacing member positioned between the first connection member and the second connection member;
receiving the core connector terminal within a cavity of a tubular insulation member; and
positioning an outer sheath around the tubular insulation member, the outer sheath including a conductive layer.

11. The method of claim 10, where the coaxial cable includes:
a dielectric layer surrounding the first core and the second core,
an outer shield conductor surrounding the dielectric layer, and
an outer insulator surrounding the outer shield conductor.

12. The method of claim 11 further comprising:
positioning the tubular insulation member to contact the dielectric layer of the coaxial cable; and
electrically coupling the conductive layer of the outer sheath to the outer shield conductor of the coaxial cable.

13. The method of claim 10, wherein the core connector terminal is crimped to the first core and the second core before the core connector terminal is received within the tubular insulation member, and wherein the tubular insulation member receives the core connector terminal before the outer sheath is positioned around the tubular insulation member.

14. The method of claim 10 further comprising:
crimping a flat, three-winged conductive element to form the core connector terminal, wherein a center wing is crimped to form the conductive spacing member.

15. The method of claim 10 further comprising:
urging a first shell of the tubular insulation member toward a second shell of the tubular insulation member to enclose the core connector terminal therebetween,
wherein the first shell and the second shell are connected via a hinge mechanism.

16. The method of claim 10 further comprising:
heating the outer sheath to constrict the outer sheath radially inward toward the coaxial cable therein,
wherein the outer sheath includes a heat shrink element positioned radially outward from the conductive layer,
wherein constricting the heat shrink element provides a water-tight seal.

17. A device for splicing a coaxial cable including a conductive core, a dielectric layer, and an outer sheath conductor, the system comprising:
a core connector terminal including:
a first connection member electrically connectable to a first end of the conductive core of the coaxial cable,
a second connection member electrically connectable to a second end of the conductive core of the coaxial cable, and
a conductive spacing member positioned between the first connection member and the second connection member; and
a tubular insulation member including:
a first shell,
a second shell,
a hinge connecting the first shell and the second shell,
a first distal end having a first width,
a second distal end having a second width, and
a cavity formed between the first shell and the second shell, the cavity positioned between the first distal end and the second distal end,
wherein the core connector terminal is receivable within the cavity of the tubular insulation member.

18. The device of claim 17, wherein the conductive spacing member includes a first stop surface to engage the first end of the conductive core, wherein the first stop surface is positioned to generate a first gap between the first connection member and the dielectric layer of the coaxial cable, and wherein the first width of the first distal end is approximately equal to the first gap to fit between the first connection member and the dielectric layer of the coaxial cable.

19. The device of claim 17, further comprising an outer sheath positioned radially outward of the tubular insulation member, the outer sheath including a conductive layer electrically connectable to the outer sheath conductor of the coaxial cable.

20. The device of claim 17, wherein a first dielectric constant of the dielectric layer is approximately equal to a second dielectric constant of the tubular insulation member, wherein the coaxial cable includes a first dielectric ratio of a first diameter of the dielectric layer compared to a second diameter of the conductive core and a second dielectric ratio of a third diameter of the tubular insulation member compared to a fourth diameter of the core connector terminal, and wherein the second dielectric ratio is approximately equal to the first dielectric ratio.
